(19) United States
(12) Patent Application Publication
(10) Pub. No.: US 2026/0024155 A1
(43) Pub. Date: Jan. 22, 2026

(54) SYSTEMS AND METHODS FOR IMPROVED TEACHER-PARENT COMMUNICATIONS

(71) Applicant: Outschool, Inc., San Francisco, CA (US)

(72) Inventors: Daniel GUILLAMOT, Fort McMurrary (CA); Jessica Monroe, Fuquay-Varina, NC (US)

(21) Appl. No.: 18/777,348

(22) Filed: Jul. 18, 2024

(51) Int. Cl. G06Q 50/20; G06F 21/62

(52) U.S. Cl. CPC G06Q 50/205; G06F 21/6263

(57) ABSTRACT

A teacher may quickly generate and transmit a customized report to a parent regarding the class performance of their child. The teacher may submit a note (details regarding the child's performance) and a prompt (either created or selected from optional prompts by the teacher or auto-selected) to an online educational platform. A Regular Expression (REGEX) may replace the child's name with a non-personal identifiable information token (non-PII token) and remove other personal identifiable information (PII) in the note. A Large Language Model (LLM) may generate a report based on the prompt and the note. The REGEX may replace the non-PII token in the report with the child's name. The online educational platform may receive and add edits from the teacher to the report. If the teacher approves the report for distribution, the report may be electronically transmitted to the parent.

### FIELD OF THE INVENTION

The present invention relates to systems and methods for an artificial intelligence (AI) teaching assistant to generate a report for a parent from a note and a prompt from a teacher.

### BACKGROUND

Teachers have used many different methods in trying to keep parents informed of their child's progress. As an example, teachers have scheduled meetings with parents, such as a parent-teacher conference, to provide an opportunity for a discussion about a student's academic performance, strengths, areas for improvement, and overall progress. However, it is not practical to hold these in-person meetings very often, resulting in parents not receiving timely information about their child.

Teachers have also sent periodic progress reports or report cards to parents, summarizing their students' achievements, grades, attendance, and behavior. These reports provide a snapshot of students' progress and facilitate ongoing communication between teachers and parents. However, these progress reports are time consuming for the teacher to generate and often arrive too late for timely action to be taken by a parent.

Many schools utilize communication apps or online platforms to share updates, announcements, assignments, and grades with parents in real-time. However, they require the parents to log into a system the parents are unfamiliar with making the information difficult to access for many parents and the information is often overgeneralized and does not, for example, provide daily information to the parents.

Teachers may send emails or newsletters to parents, providing updates on classroom activities, curriculum topics, upcoming events, and opportunities for parental involvement. However, producing emails for each student is very time consuming. Newsletters by their very nature do not provide specific information regarding a particular student, giving parents only a very general understanding of how their child is doing in their class.

In addition to written communication, teachers have made phone calls to parents to discuss students' progress, address concerns, or provide individualized feedback. However, parents typically do not want frequent phone calls from a teacher (unless there is an emergency) and it may be difficult for a parent and teacher to be available at the same time. In addition, preparing for a phone call (where any topic could be raised) can be time consuming for the teacher.

Some teachers use homework or assignment logs to track students' completion of tasks and share this information with parents. However, this information is usually not very timely or detailed, thus not allowing parents to take timely action when needed.

Teachers may maintain classroom websites or online portals where they post class materials, resources, assignments, and grades. Again, due to time constraints and/or technology constraints it is difficult for many parents to access these resources and these resources tend to be generalizations of performance over extended periods of time.

Applicants have discovered that there is needed an improved method for a teacher to inform a parent in a timely manner of their child's classroom progress.

### SUMMARY OF THE INVENTION

Accordingly, the invention is directed to systems and methods for an artificial intelligence (AI) teaching assistant to generate a customized report for a parent from a note and a prompt created by a teacher.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the figures.

Most teachers have back-to-back classes with 5 to 10 minutes breaks in between. The teachers do not have time to write down a class summary for each student after each class session. If the teacher leaves this for an end-of-day task, it might take much longer to recall and compose a customized report for each student. Even most tutoring sessions do not end with the tutor drafting and sending a customized report to the parent due to the time it takes to generate a customized report. It also does not look very professional if the teacher or tutor tries to save time by sending a short bullet-point note to the parent.

An advantage of the present invention is that the teacher/tutor, in a very short period of time, can have a professionally looking customized report sent to the parent in a timely manner.

The teacher may access a web interface on an online educational platform after completing a class or a tutoring session for a student. One or more servers of the online educational platform may receive a prompt, e.g., a desired format or style, and a note, e.g., specific details regarding the student's performance in the class from the teacher. In other embodiments, the online educational platform may receive a note from the teacher, but the prompt may be created by the online educational platform and may not be changed by the teacher. In another embodiment, the online educational platform may receive a note from the teacher and may give the teacher two or more prompts to choose from as options, possibly using descriptive icons from which the teacher may select a desired prompt.

A Regular Expression (REGEX) may replace a learner's name with a non-personal identifiable information token (non-PII token). The REGEX may also remove other PII in the note.

A Large Language Model (LLM) may be called and receive the prompt and the note after the REGEX removed the PII. The LLM may generate a report based on the prompt and the note. The REGEX may replace the non-PII token with the learner's name in the report.

The one or more backend servers via the web interface on the online educational platform may provide an opportunity to the teacher to edit and/or approve the report for distribution. The one or more backend servers may receive and add any edits from the teacher to the report. If the teacher approves the report for distribution, the one or more backend servers may electronically transmit the report to the parent. If the report is not approved by the teacher, the report is not sent to the parent.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serving to explain the principles of the invention.

In the drawings:

FIG. 1 is a diagram of an example system that may be used to practice the invention.

FIG. 2 is a diagram of another example system that may be used to practice the invention.

FIG. 3 is the first part of a flowchart illustrating an example method of practicing the invention.

FIG. 4 is the second part of the flowchart in FIG. 2 illustrating the example method for practicing the invention.

FIG. 5 is an example of a web page that may be used to receive a note in a note field and a prompt in a prompt field from a user, where the note and the prompt that may be used to create a report.

FIG. 6 is an example of a web page that is displaying an example note in the note field along with an active “Show me the magic” icon and an inactive “Send Note to Family” icon.

FIG. 7 is an example of a web page after the “Show me the magic” icon has been selected and the system is busy generating a report from the provided note and the provided prompt.

FIG. 8 is an example of a web page after the system has generated the report and displayed the report in a report field, where the web page displays options for customizing the report prior to transmitting the report to the parents using the “Send Note to Family” icon button.

### DETAILED DESCRIPTION OF THE ILLUSTRATED EMBODIMENTS

The following detailed description describes a system and method for an artificial intelligence (AI) teaching assistant to generate a report for a parent from a note and a prompt from a teacher and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purpose of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

As used hereinafter, “teacher” should be broadly construed and specifically includes a teacher, educator, instructor, professor, mentor or tutor. In other words, a teacher is anybody that performs an educational activity with a student (which may last less than a day, e.g. a half hour or an hour, or may last several days, weeks or months) and then desires to inform the parent(s) of the student on how the student performed during the educational activity.

As used hereinafter, “parent” or “parents” should be construed to include biological/legal parent(s) and/or any other legal guardians of the child (who is the student) who are entitled to receive a report containing class information regarding the student.

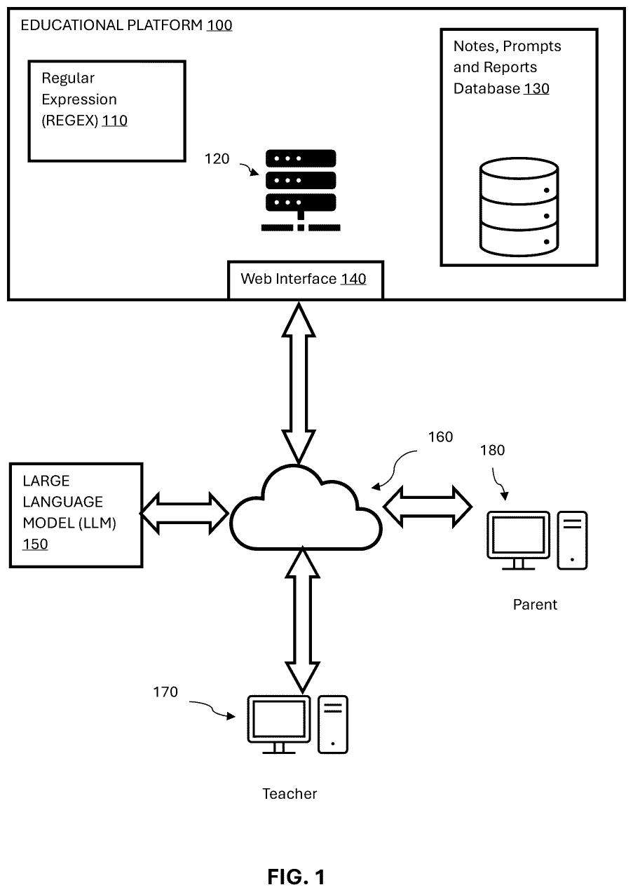

Referring to FIG. 1, a system and method for an artificial intelligence (AI) teaching assistant to generate a report for a parent 180 from a note and a prompt from a teacher 170 is illustrated.

Online learning is a method of learning that utilizes digital technologies and the internet 160. It enables students to access educational materials, participate in lectures with a teacher, complete assignments, and interact with teachers and classmates entirely through an online educational platform 100 using a user electronic device, such as a computer, laptop or smart phone. This mode of education can involve synchronous learning, where real-time interaction occurs through live video conferencing, and asynchronous learning, where students access pre-recorded lectures for classes and course materials, such as videos, at their own pace. Online learning offers flexibility in scheduling, accessibility to a wide range of courses and instructors, and the ability for students to learn at their own pace. However, it also presents challenges such as the need for self-discipline and potential technical issues.

In-person learning with a teacher 170 involves face-to-face instruction where a student (or a plurality of students) receives personalized guidance and support from the teacher 170. Typically conducted in a physical setting such as a classroom, library, or private study space, this approach allows for direct interaction, immediate feedback, and tailored instruction to meet the individual needs of the student. The teacher 170 provides one-on-one attention, clarifies concepts, offers additional resources, and assists the student in achieving their academic goals through interactive and dynamic teaching methods. This traditional form of education fosters a close student-teacher relationship, facilitating a deeper understanding of the subject matter and promoting active engagement in the learning process.

In the development of an online educational platform 100, the hardware infrastructure to support that online educational platform 100 includes many computer components (generally referred to as backend servers 120) working in conjunction to support delivery of educational content, facilitate interactive learning experiences, and ensure robust performance and reliability. The hardware elements for such an online educational platform may include but are not limited to 1) one or more servers to execute and support core application logic, databases, and content repositories, 2) networking hardware to enable remote communication between devices, where such hardware may include routers, switches, and firewalls, and 3) data storage and retrieval systems, such as network-attached storage (NAS) or storage area networks (SAN), that provide scalable and fault-tolerant storage capacity for hosting educational content, multimedia files, and user-generated data.

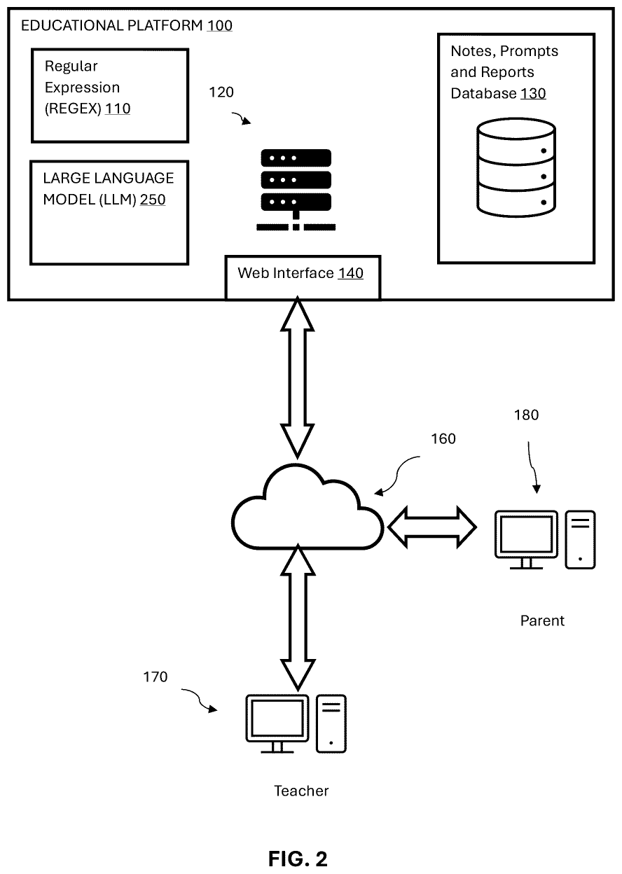

To illustrate an example of such an infrastructure, FIGS. 1 and 2 illustrate an online educational platform 100 that includes a notes, prompts and reports database 130 that stores corresponding notes, prompts and reports received from one or more teachers, with each teacher 170 associated with one or more students, with each teacher/student pair associated with one or more notes, prompts and reports.

The online educational platform 100 also includes a web interface 140. The web interface 140 may be a user interface that allows users to interact with web-based applications or a website through a graphical interface displayed in a web browser. The web interface 140 may consist of visual elements, such as menus, buttons, forms, and other interactive components, that users can interact with to perform actions or access information. The web interface 140 presents content and functionality in a structured and accessible manner, enabling users to navigate, input data, and interact with the underlying system or application. It may incorporate various design principles, such as responsiveness, accessibility, and usability, to ensure a seamless and intuitive user experience across different devices and platforms.

The online educational platform 100 also includes a Regular Expression Engine (REGEX) 110. REGEX 110 may be configured to implement one or more pre-determined regular expression string matching rules or templates. A regular expression is a sequence of characters that forms a search pattern, used mainly for pattern matching within strings. It consists of a combination of letters, digits, and special characters that define a specific pattern to be searched for within a larger body of text. The REGEX 110 provides a powerful and flexible means of searching, matching, and manipulating textual data based on specific criteria, such as finding all instances of a particular word or pattern, validating input formats, or extracting relevant information from a string. For optimized performance, a REGEX 110 should be run on a Graphics Processing Unit (GPU).

The online educational platform 100 may access a third-part Large Language Model (LLM) 150 (third-party LLM) as shown in FIG. 1, such as using an Application Program Interface (API) offered by the third party, or the online educational platform 100 may include an LLM 250 integrated into the online educational platform 100 as shown in FIG. 2. An LLM 150, 250 is preferably a sophisticated artificial intelligence system designed to understand and generate human-like text based on vast amounts of training data. The LLM 150, 250 may leverage advanced natural language processing techniques and machine learning algorithms to analyze and comprehend the structure, semantics, and context of textual input. By processing extensive corpora of text, which can include books, articles, websites, and other sources of written language, the LLM 150, 250 may learn patterns, associations, and linguistic nuances inherent in human communication. This enables the LLM 150, 250 to generate coherent and contextually relevant responses to user queries, engage in conversations, perform language translation, summarize information, and undertake various text-based tasks. For optimized performance, the LLM 150, 250 should be run on a Graphics Processing Unit (GPU) and/or a Tensor Processing Unit (TPU).

Teachers 170 and parents 180 may access (transmit to and/or receive information from) the online educational platform 100 using any desired type of electronic device. As non-limiting examples, the teachers 170 and/or parents 180 may access the web interface 140 of the online educational platform 100 using a computer, laptop, or smartphone.

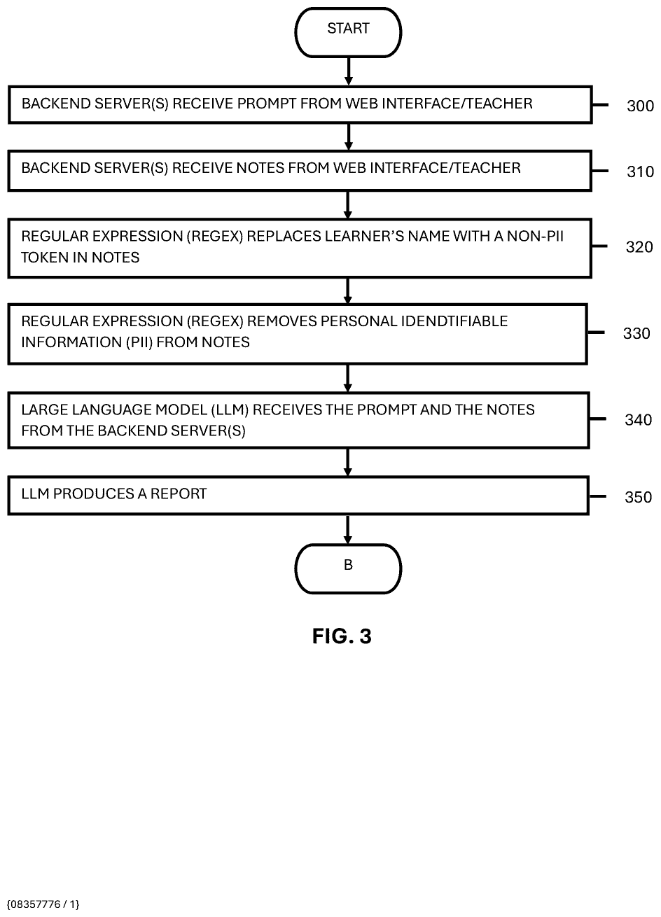

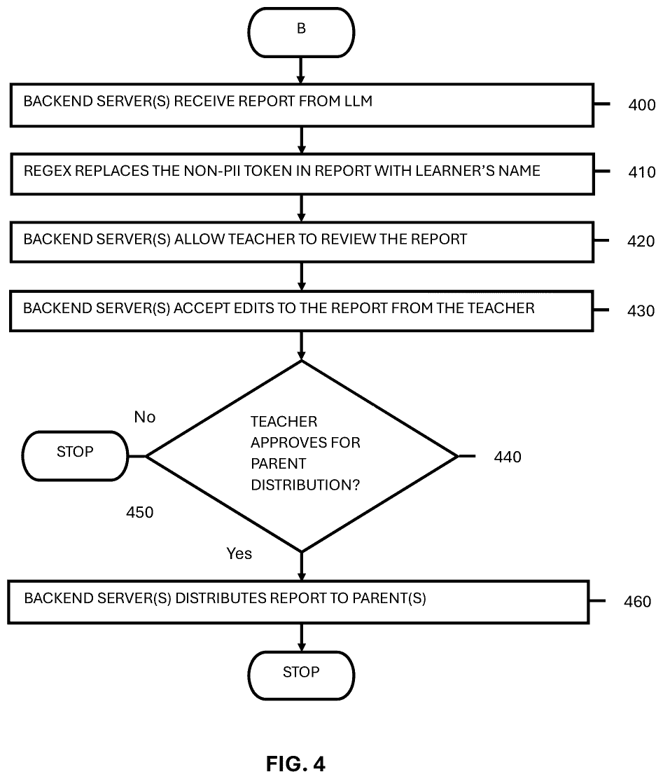

Referring to FIGS. 3 and 4, an example system and method will now be provided for a system and method for an artificial intelligence (AI) teaching assistant to generate a report for a parent 180 from a note and a prompt from a teacher 170.

A teacher 170 and a student (with or without other students) may engage in any desired format of a learning experience. The learning experience may be online or in person. As non-limiting examples, the teacher 170 and student may have a class, tutor session, direct instruction, facilitated discussion, small group activity, one-on-one instruction, and/or hands-on learning session. During the learning experience the teacher 170 may evaluate how the student did during the learning experience.

Parents 180 often want to know how their child did during the learning experience for many possible different reasons. As non-limiting examples, parents 180 may want to monitor the progress of their child, support the learning of their child and/or identify strengths and weakness of their child to help in the development of their child.

Teachers 170 often want to keep the parents 180 informed on the status of their students to keep the parents 180 engaged, supportive and involved with the learning process, provide early intervention options to the parents 180 when the student is struggling and provide individualized support as the needs of every student are different. If the teacher 170 is a paid tutor, the tutor may desire to keep the parent 180 informed and engaged to help retain the parent 180 and child as customers. However, many teachers have a limited amount of time to keep the parent 180 informed of their child's learning experience progress.

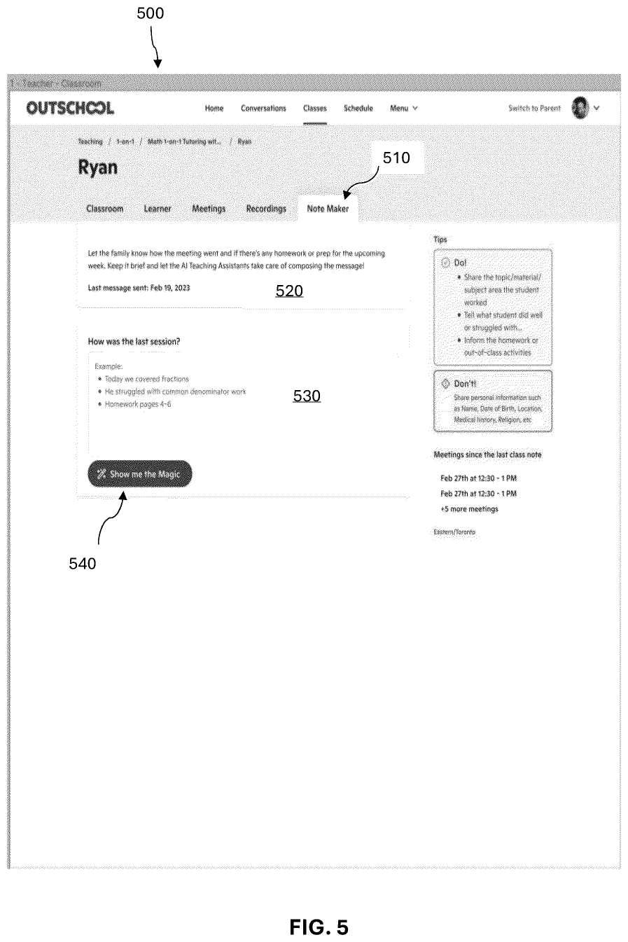

To help improve this situation, a system and method have been developed for an artificial intelligence (AI) teaching assistant to generate a report for the parent 180 from a note and a prompt from either the teacher 170 or the online educational platform 100. Referring to FIG. 5, a teacher 170 may enter a note into a note field 530 and a prompt into a prompt field 520 in a web page 500. In other embodiments, the prompt field 520 may be used to direct the teacher 170 in how to complete the note field 530 and the prompt may be generated by the online educational platform 100. Once submitted, one or more backend servers 120 may receive the note and the prompt via the web interface 140 of the online educational platform 100. (Steps 300 and 310)

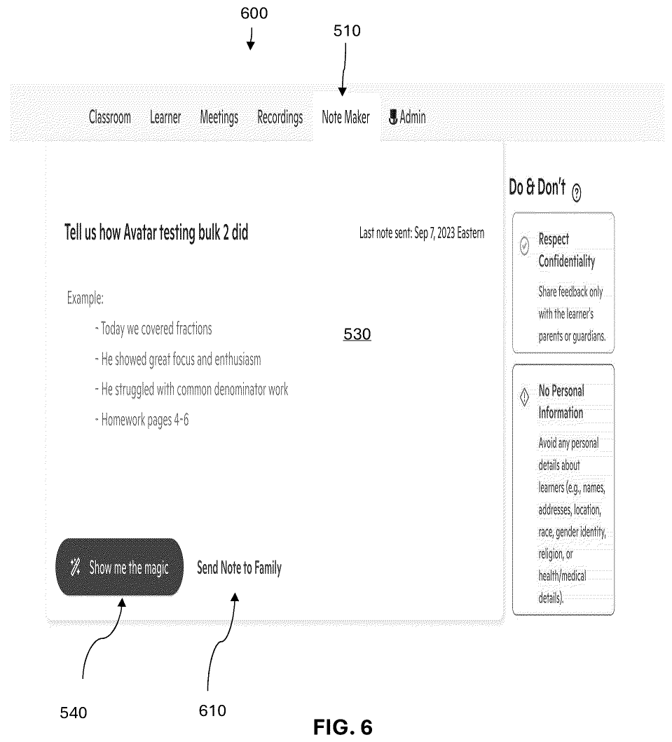

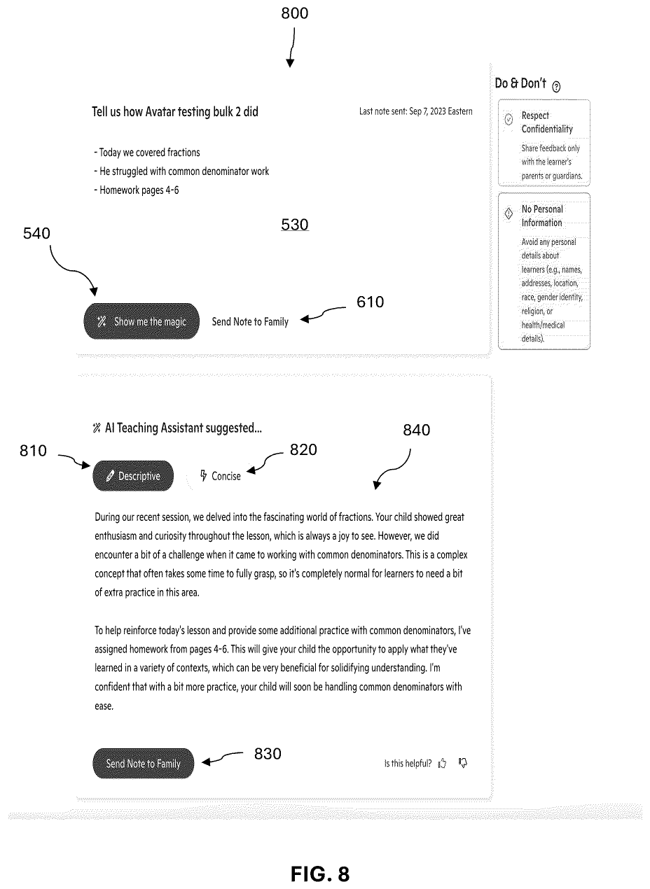

Referring to FIGS. 6-8, another embodiment is illustrated. In this embodiment, the teacher 170 does not have to enter the prompt. One, two or a plurality of different prompts, that have been tested and found to generate desirable reports, may be saved by the online educational platform 100. In some embodiments, the teacher 170 may automatically use the one provided prompt. In other embodiments, the teacher 170 may be given a list of two or more prompts that may be used, preferably with a descriptive title identifying the prompts. As a non-limiting example, FIG. 8 allows the teacher 170 to select a prompt that produces a more “descriptive” 810 report or a prompt that produces a more “concise” 820 report. While FIG. 8 shows two possible prompts, in other embodiments, any desired number of different prompts may be selected by the teacher 170.

Referring to FIG. 6, a web page 600 is displaying an example note in a note field 530 along with an active “Show me the magic” icon 540 and an inactive “Send Note to Family” icon 610. In practice the note field 530 would be empty prior to the teacher 170 entering the note in the note field 530. The web page 600 may be used to enter or receive other types of data in other types of fields, but the “Note Maker” tab 510 has been selected in this example. The illustrated example note entered by the teacher 170 is: “—Today we covered fractions;” “—He showed great focus and attention;” “—He struggled with common denominator work;” and “—Homework pages 4-6.” After the teacher 170 is satisfied with the note in the note field 530, the teacher 170 may select “Show me the magic” icon 540 to start generating a report. It should be appreciated that the “Show me the magic” icon 540 may be labeled in any desired manner. As a non-limiting example, the “Show me the magic” icon 540 may be labeled “Generate a Report” or any other text or image that cues the teacher 170 that a report may now be generated based on the entered note in the note field 530.

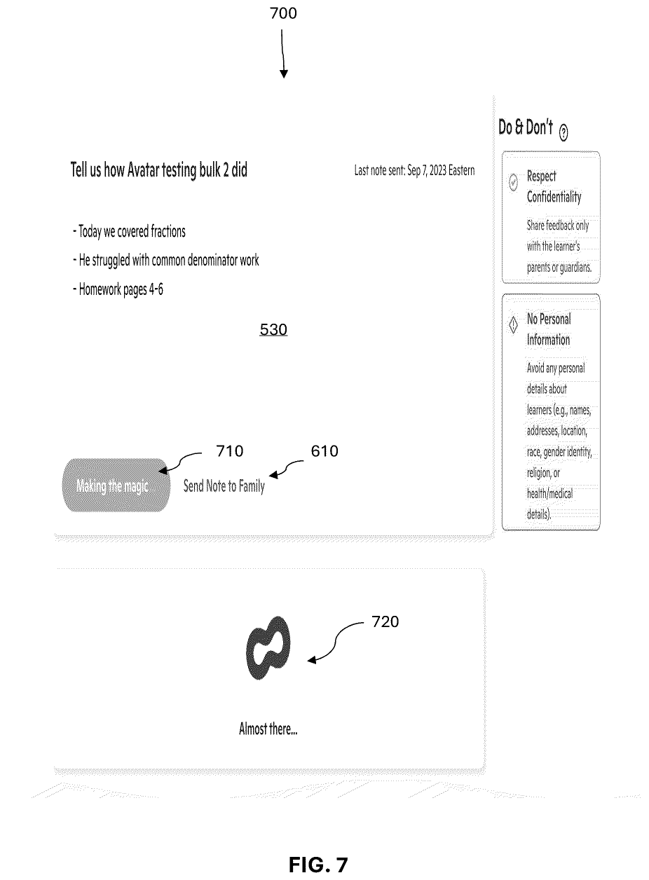

Referring to FIG. 7, a web page 700 may be displayed with a busy icon 720 while the online educational platform 100 is generating a report after the teacher 170 has selected the “Show me the magic” icon 540. The “Show me the magic” icon 540 may be changed to an inactive “Making the magic” icon 710 (or as another non-limiting example, a “Generate a report” icon may be replaced with a “Generating a report” icon).

A Regular Expression (REGEX) may be used to replace a learner's name with a non-PII token in the notes as the notes may contain the student's name and possibly other personal identifiable information (PII). The PII of the student should be protected for many different reasons. As non-limiting examples, the PII may raise privacy concerns, security risks, legal compliance issues, trust and reputation concerns and ethical considerations. It is thus preferably removed by the REGEX. (Step 320) In addition, the REGEX may also remove other PII from the notes. (Step 330)

An LLM may be called and given the notes and the prompt from the teacher 170 for the student. (Step 340) The prompt for the LLM 150, 250 may be a specific input provided to the LLM 150, 250 to generate a report. The prompt may serve as a cue or instruction that guides the LLM 150, 250 in producing a text-based output, i.e., the report, according to a desired format or style of report. The prompt can take various forms, including a sentence, a paragraph, or even a structured set of instructions, and it typically contains the necessary context, information, or criteria for the LLM 150, 250 to generate a relevant and coherent report in the desired format. Typically, the same prompt may be saved and used by the teacher 170 for many different students in the same class.

The notes for the LLM 150, 250 are preferably specific for each student's performance during the learning experience. The LLM 150, 250 uses the notes to generate a report that is customized to the student.

The LLM 150, 250 may produce a report based on the note and the prompt. (Step 350) To produce the report based on the prompt and the note, the LLM 150, 250 may follow any desired steps. As non-limiting examples, the LLM 150, 250 may perform one or more of the following steps.

The LLM 150, 250 may receive the prompt and the note as input. The prompt may serve as an initial cue or instruction, providing context and guiding the generation process. The note may contain relevant information, such as the teacher 170 provided performance data of the student.

The LLM 150, 250 may analyze the prompt and the note to understand the context, objectives, and requirements of the report. The LLM 150, 250 may identify key information, themes, and relationships within the input to inform the generation process of the report.

Using the LLM's 150, 250 understanding of the input context, the LLM 150, 250 may generate the report text based on the prompt and the note. The LLM 150, 250 may synthesize the information from the note, incorporates relevant details, and structures the report content according to the specified format or guidelines provided in the prompt.

The LLM 150, 250 may expand upon the information provided in the note by generating additional details, explanations, examples, or insights to enrich the content of the report. The LLM 150, 250 leverages its knowledge of language patterns, domain-specific terminology, and logical coherence to produce coherent and informative text for the report.

Throughout the text generation process, the LLM 150, 250 may utilize its language modeling capabilities to ensure grammatical correctness, fluency, and coherence of the text for the report. The LLM 150, 250 may generate sentences, paragraphs, and sections that flow naturally and convey the intended meaning effectively.

After generating the text for the report, the LLM 150, 250 may conduct internal checks to assess the quality and relevance of the output. The LLM 150, 250 may evaluate factors such as factual accuracy, coherence, clarity, conciseness, and adherence to the prompt and the note.

The LLM 150, 205 may present the generated report text as output, which may include structured sections, headings, subheadings, bullet points, or other formatting elements as specified.

The one or more backend servers 120 of the online educational platform 100 may receive the output, i.e., the report, from the LLM 150, 250. (Step 400)

The REGEX may replace the token in the report with the learner's name. (Step 410)

Referring to FIG. 8, the web interface 140 of the online educational platform 100 may provide the report 840 on a webpage 800 for the teacher 170 for review. (Step 420) The teacher 170 may edit the notes in the note field 530 and select the “Show me the magic” icon 540 to generate a new report 840 based on the edited notes.

The one or more backend servers 120 via the web interface 140 may receive one or more edits on the webpage 800 from the teacher 170 to the report 840 and update the report 840 according to the teacher's edits. (Step 430)

The teacher 170 may enter and edit the notes (step 300) to create a new report 840 as many times as desired by the teacher 170. The teacher 170 may edit the report 840 on the webpage 800 (step 430) as may times as desired by the teacher 170, until the report 840 is approved by the teacher 170. In some embodiments, the teacher 170 does not personally edit the report 840, but he report 840 may be updated by the teacher 170 selecting another icon that generates a new report 840 based on a new style. As non-limiting examples, webpage 800 gives the teacher 170 a “Descriptive” icon 810 and a “Concise” icon 820 that may be selected by the teacher 170 to generate a new report 840 based on which icon 810, 820 is selected. It should be appreciated that any number of different styles with corresponding icons may be presented to the teacher 170 for selection on the webpage 800 to generate a new report 840 based on the newly selected icon.

As a first example, a prompt, either entered by the teacher 170 or provided by the online educational platform 100 as a template prompt, may be “An Outschool teacher had a 1:1 session with a learner and has some notes to share with the parent. From the notes of the teacher, create a progress report in a few paragraphs, for the parent of the learner to read.—Use all information in the notes.—Do not include any information that is not in the notes.—Do not include a greeting or sign off.—Keep the report concise and avoid elaborating beyond the information provided by the teacher.—Use a warm language, try to avoid dry corporate like style.”

The notes entered by the teacher 170 in the first example may be “Samuel passed on his Essential Elements songs and has started 2 new ones, Pop Goes the Weasel and Surprise Symphony, numbers 176 and 182. He can continue to practice Etude in his Suzuki book. He worked hard reading the notes for Etude, paying close attention to what string the note is on. Well done.”

The report 840 generated based on the provided prompt and the provided notes in the first example may be “Samuel has made significant progress in his music lessons. He has successfully completed his Essential Elements songs and has enthusiastically started two new ones, namely ‘Pop Goes the Weasel’ and ‘Surprise Symphony’, which are numbers 176 and 182 respectively. In addition to these new songs, Samuel can continue to practice ‘Etude’ from his Suzuki book. He has shown great dedication and effort in reading the notes for ‘Etude’, demonstrating a keen attention to detail by carefully identifying the string each note is on. Overall, Samuel's hard work and progress are commendable. His dedication to learning and improving his musical skills is evident in his practice and performance. Well done, Samuel!”

As a second example, a prompt, either entered by the teacher 170 or provided by the online educational platform 100 as a template prompt, may be “An Outschool teacher had a 1:1 session with a learner and has some notes to share with the parent. From the notes of the teacher, create a progress report in a few paragraphs, for the parent of the learner to read. Have a warm/happy/bubbly tone.—Use all information in the notes.—Do not include any information that is not in the notes.—Do not include a greeting or sign off.—Keep the report concise and avoid elaborating beyond the information provided by the teacher.—Use a warm language, try to avoid dry corporate like style.”

The notes entered by the teacher 170 in the second example may be “—Covered ½, ¼, and ⅛ fractions in class today—good engagement; emerging mastery in word problems—didn't compete homework; needs to practice more—this week: Homework pages 6-8”

The report 840 generated based on the provided prompt and the provided notes in the second example may be “Your child made some wonderful strides in our session today! We dove into the world of fractions, specifically focusing on ½, ¼, and ⅛. Your learner showed great engagement and is beginning to master word problems involving these fractions. It's such a joy to see their understanding grow! However, it seems that the homework wasn't completed this time around. Homework is a crucial part of the learning process as it helps to reinforce what we cover in class. So, a little more practice outside of our sessions would be beneficial for your child's progress. Looking ahead, we'll be working on pages 6-8 for this week's homework. I'm confident that with a bit more practice, your child will continue to blossom in their understanding of fractions. Keep up the great work!”

The one or more backend servers 120 may store the note, prompt and report 840 in a notes, prompts and reports database 130 for later reference by the teacher 170.

The one or more backend servers 120 may provide an option on the webpage for the teacher 170 to approve electronically transmitting the report 840 to a parent 180. (Step 440) As a non-limiting example, the teacher 170 may be provided a “Send Note to Family” icon 830 (which may in other embodiments have any other desired text and/or graphic), that when selected, sends the final displayed report 840 to one or more parents 180 of the student.

If the teacher 170 approves on the webpage transmitting the report 840 to the parent 180, the one or more backend servers 120 may electronically transmit the report 840 to the parent 180. (Step 460) The report 840 may be sent in any desired digital format. As non-limiting examples, the report 840 may be sent as a text message, email and/or a messages API. If the teacher 170 does not approve on the webpage transmitting the report 840 to the parent 180, the one or more backend servers 120 do not transmit the report 840 to the parent 180. (Step 450)

In some embodiments, the educational platform 100 may be used to provide feedback via an online platform in conjunction with educational activities occurring through channels other than the education platform 100 (e.g., via in-person live classes or other channels). In other words, teachers 170 may still use the educational platform 100 to send a report 840 to a parent 180 even when the educational activities are not directly related to or performed by the educational platform 100.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for an artificial intelligence (AI) teaching assistant to generate a report for a parent, comprising the steps of:
receiving, by one or more backend servers, a prompt via a web interface on an online educational platform from a teacher;
receiving, by the one or more backend servers, a note via the web interface on the online educational platform from the teacher;
replacing, by a Regular Expression (REGEX), a learner's name with a non-personal identifiable information token (non-PII token);
removing, by the REGEX, personal identifiable information (PII) in the note;
receiving, by a Large Language Model (LLM), the prompt and the note after the REGEX removed the PII;
generating, by the LLM, a report based on the prompt and the note;
receiving, by the one or more backend servers, the report from the LLM;
replacing, by the REGEX, the non-PII token with the learner's name in the report;
receiving, by the one or more backend servers, approval to electronically transmit the report to a parent; and
transmitting, by the one or more backend servers, the report to the parent.

2. The method of claim 1, wherein the prompt comprises a format or style for the report.

3. The method of claim 1, wherein the note comprises a plurality of details corresponding to a student during an educational activity.

4. The method of claim 1, wherein the report was edited by the teacher via the web interface prior to the report being transmitted to the parent.

5. The method of claim 1, wherein the REGEX is configured to search, match, and manipulate textual data based on specific criteria.

6. The method of claim 1, wherein the LLM is a third-party LLM that the online educational platform may access over the Internet.

7. The method of claim 1, wherein the online educational platform comprises the LLM.

8. A method for an artificial intelligence (AI) teaching assistant to generate a report for a parent, comprising the steps of:
accessing, by one or more backend servers, a prompt from a database;
receiving, by the one or more backend servers, a note via a web interface on an online educational platform from a teacher;
replacing, by a Regular Expression (REGEX), a learner's name with a non-personal identifiable information token (non-PII token);
removing, by the REGEX, personal identifiable information (PII) in the note;
receiving, by a Large Language Model (LLM), the prompt and the note after the REGEX removed the PII;
generating, by the LLM, a report based on the prompt and the note;
receiving, by the one or more backend servers, the report from the LLM;
replacing, by the REGEX, the non-PII token with the learner's name in the report;
receiving, by the one or more backend servers, approval to electronically transmit the report to a parent; and
transmitting, by the one or more backend servers, the report to the parent.

9. The method of claim 8, wherein the prompt comprises a format or style for the report.

10. The method of claim 8, wherein the note comprises a plurality of details corresponding to a student during an educational activity.

11. The method of claim 8, wherein the report was edited by the teacher via the web interface prior to the report being transmitted to the parent.

12. The method of claim 8, wherein the REGEX is configured to search, match, and manipulate textual data based on specific criteria.

13. The method of claim 8, wherein the LLM is a third-party LLM that the online educational platform may access over the Internet.

14. The method of claim 8, wherein the online educational platform comprises the LLM.

15. A method for an artificial intelligence (AI) teaching assistant to generate a report for a parent, comprising the steps of:
accessing, by one or more backend servers, a plurality of prompts from a database;
receiving, by the one or more backend servers, a prompt selected by a teacher from the plurality of prompts;
receiving, by the one or more backend servers, a note via a web interface on an online educational platform from the teacher;
replacing, by a Regular Expression (REGEX), a learner's name with a non-personal identifiable information token (non-PII token);
removing, by the REGEX, personal identifiable information (PII) in the note;
receiving, by a Large Language Model (LLM), the prompt and the note after the REGEX removed the PII;
generating, by the LLM, a report based on the prompt and the note;
receiving, by the one or more backend servers, the report from the LLM;
replacing, by the REGEX, the non-PII token with the learner's name in the report;
receiving, by the one or more backend servers, approval to electronically transmit the report to a parent; and
transmitting, by the one or more backend servers, the report to the parent.

16. The method of claim 15, wherein the prompt comprises a format or style for the report.

17. The method of claim 15, wherein the note comprises a plurality of details corresponding to a student during an educational activity.

18. The method of claim 15, wherein the report was edited by the teacher via the web interface prior to the report being transmitted to the parent.

19. The method of claim 15, wherein the LLM is a third-party LLM that the online educational platform may access over the Internet.

20. The method of claim 15, wherein the online educational platform comprises the LLM.
